(19) United States
(12) Patent Application Publication
(10) Pub. No.: US 2019/0361131 A1
(43) Pub. Date: Nov. 28, 2019

(54) MONITORING SYSTEM

(71) Applicant: KYOCERA Document Solutions Inc., Osaka (JP)

(72) Inventor: Keiji SAKABE, Osaka (JP)

(73) Assignee: KYOCERA Document Solutions Inc., Osaka (JP)

(21) Appl. No.: 16/415,902

(22) Filed: May 17, 2019

(30) Foreign Application Priority Data
May 24, 2018 (JP) 2018-099266

(51) Int. Cl. G01S 19/24; G01S 19/32; H04W 4/029; H04W 4/021; G06F 21/32; G06F 9/54

(52) U.S. Cl. CPC G01S 19/24; G01S 19/32; G06F 9/542; H04W 4/021; G06F 21/32; H04W 4/029

(57) ABSTRACT

A monitoring system has a subject terminal, a monitoring device, and a watcher terminal connected via a network. The monitoring device includes an abnormality detecting portion, a mode switching portion, and a position tracking portion. The subject terminal includes a termination acceptance portion. The termination acceptance portion, in the abnormality monitoring mode, accepts the termination input, and transmits the accepted termination input to the monitoring device. The watcher terminal includes a tracking information output portion. The tracking information output portion, in the abnormality monitoring mode, outputs the position of the subject terminal received from the monitoring device.

### INCORPORATION BY REFERENCE

This application is based upon and claims the benefit of priority from the corresponding Japanese Patent Application No. 2018-099266 filed on May 24, 2018, the contents of which are hereby incorporated by reference.

### BACKGROUND

The present disclosure relates to a monitoring system for monitoring a watched subject based on position information.

Modern mobile terminals such as mobile phones and smartphones have a GPS (global positioning system) function and a function for wireless communication with access points. Thus, a technology has been proposed where, for example, a watched subject such as an elderly person or a minor carries a mobile terminal and a watcher monitors the watched subject based on position information.

Inconveniently, however, with the conventional technology, the situation of the watched subject cannot be grasped. That is, it is difficult for a watcher him or herself to act to check the situation even if an abnormality notification based on position information is received. In addition, even if an abnormality notification is received, in most cases, there is actually no problem. Thus, abnormality notifications may become annoying and the watcher may gradually cease to check abnormality notifications.

The present invention has been made to solve the above problems and its object is to provide a monitoring system in which the situation of a subject can be grasped during abnormality notification.

### SUMMARY

According to one aspect of what is disclosed herein, a monitoring system has a subject terminal, a monitoring device, and a watcher terminal connected via a network. A subject carries the subject terminal. The monitoring device monitors the position of the subject terminal. A watcher watching the subject carries the watcher terminal. The monitoring device includes an abnormality detecting portion, a mode switching portion, and a position tracking portion. The abnormality detecting portion senses an abnormality when the position of the subject terminal goes outside a set activity range. When the abnormality detecting portion senses an abnormality, the mode switching portion transmits an abnormality monitoring notification indicating a switch to an abnormality monitoring mode to the subject terminal and the watcher terminal. The mode switching portion, upon receiving from the subject terminal a termination input requesting for the termination of the abnormality monitoring mode, transmits a termination notification indicating the termination of the abnormality monitoring mode to the subject terminal and the watcher terminal. The position tracking portion transmits the position of the subject terminal to the watcher terminal in the abnormality monitoring mode. The subject terminal includes a termination acceptance portion. The termination acceptance portion, in the abnormality monitoring mode, accepts the termination input, and transmits the accepted termination input to the monitoring device. The watcher terminal includes a tracking information output portion. The tracking information output portion, in the abnormality monitoring mode, outputs the position of the subject terminal received from the monitoring device.

This and other objects of the present disclosure, and the specific benefits obtained according to the present disclosure, will become apparent from the description of embodiments which follows.

### BRIEF DESCRIPTION OF THE DRAWINGS

FIG. 1 is a system configuration diagram showing an outline of the configuration of a monitoring system according to an embodiment of the present disclosure;

FIG. 2 is a diagram showing an installation example of access points shown in FIG. 1;

FIG. 3 is a block diagram showing a configuration of a monitoring device shown in

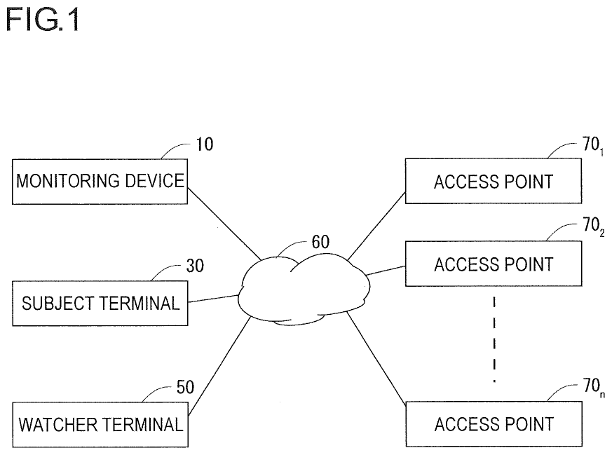

FIG. 1;

FIG. 4 is a block diagram showing a configuration of a subject terminal and a watcher terminal shown in FIG. 1; and

FIG. 5 is a flow chart illustrating operation of the monitoring device shown in FIG. 1.

### DETAILED DESCRIPTION

Hereinafter, with reference to the accompanying drawings, an embodiment of the present disclosure will be described in detail. In the embodiment described below, elements with similar functions are assigned the same reference signs.

In a monitoring system according to this embodiment, as shown in FIG. 1, a monitoring device 10, a subject terminal 30, and a watcher terminal 50 are connected together via a network 60 such as the Internet. In the monitoring system of this embodiment, a watched subject such as an elderly person or a minor (for example, a school child) carries around the subject terminal 30, and the monitoring device 10 watches and monitors the position of the subject terminal 30 as the position of the subject.

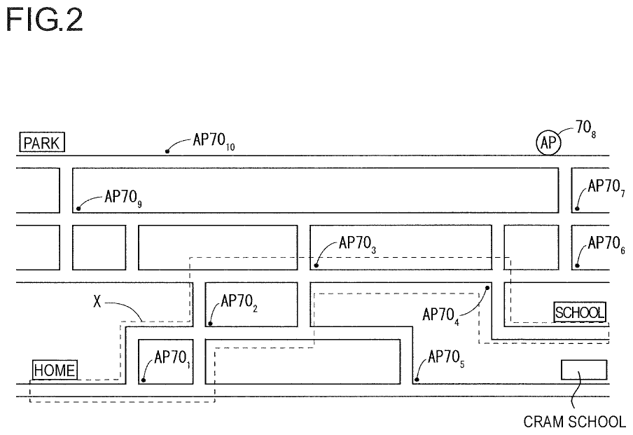

To the network 60, a plurality of access points (hereinafter, called APs) 70₁ to 70ₙ are connected which are capable of wireless communication with the subject terminal 30. The APs 70₁ to 70ₙ are communication devices such as those based on Wi-Fi and Bluetooth (a registered trade-mark) with a limited communication range at public Wi-Fi access points and the like, and, as shown in FIG. 2, they are installed all over a town. FIG. 2 shows an example where setting APs 70₁ to 70₁₀ are installed around a school, a cram school, and a park.

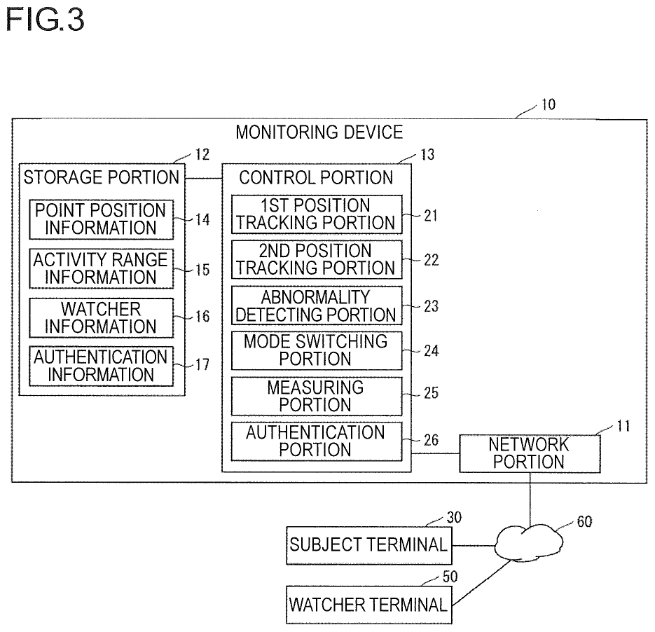

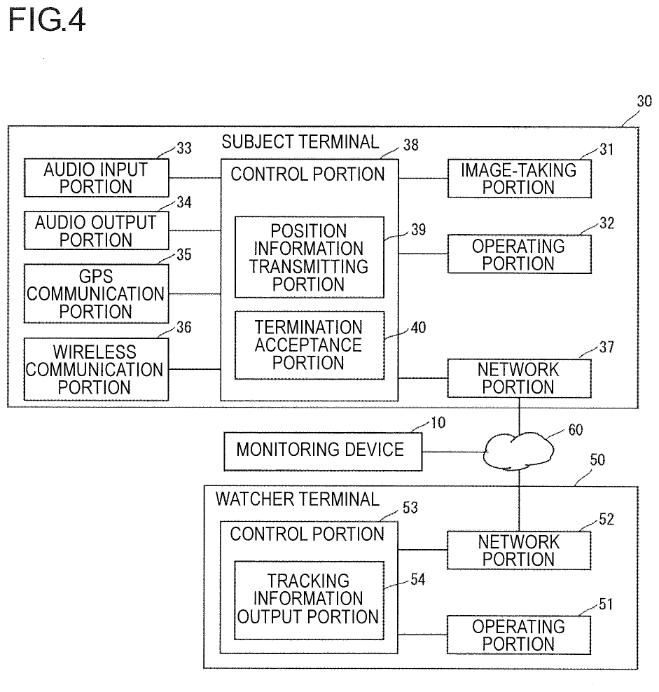

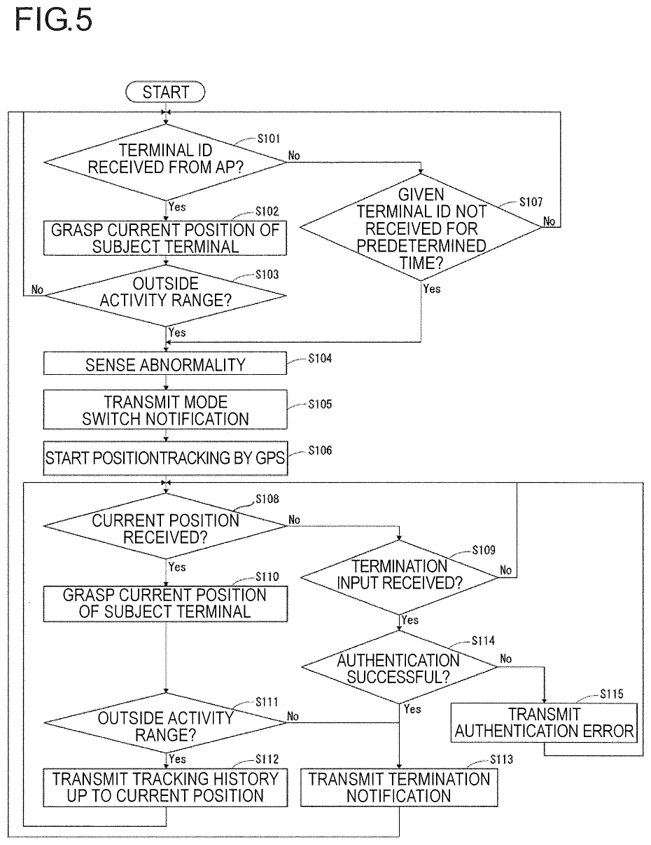

The monitoring device 10 is an information processing device such as a server. The monitoring device 10 may be configured as a virtual server built on a cloud computing service. The monitoring device 10 includes, as shown in FIG. 3, a network portion 11, a storage portion 12, and a control portion 13.

The network portion 11 has a function of transmitting and receiving various types of data via the network 60 to and from the subject terminal 30, the watcher terminal 50, and the APs 70₁ to 70ₙ.

The storage portion 12 is a means of storage such as a semiconductor memory and an HDD (hard disk drive). In the storage portion 12, point position information 14, activity range information 15, watcher information 16, and authentication information 17 are registered.

The point position information 14 is information indicating the installation locations of the APs 70₁ to 70ₙ (for example, the longitude and latitude).

The activity range information 15 is information indicating the activity range of each subject (for example, a commuting route). The activity range of each subject is associated with the terminal ID of the subject terminal 30. The activity range is determined as a region in a polygonal shape or a circular shape having as its apexes or center the points defined by longitudes and latitudes. The activity region can be changed depending on the time zone or the day of the week. FIG. 2 shows an example where the commuting route of subject A from home to school is set as activity range X. The APs 70₁ to 70₄ are installed inside activity range X of subject A, and the APs 70₄ to 70₁₀ are installed outside activity range X of subject A.

The watcher information 16 indicates contact information of a watcher. The terminal ID of the watcher terminal 50 is registered in association with the terminal ID of the subject terminal 30.

The Authentication information 17 is information for verifying whether an operator who operates the subject terminal 30 is a subject himself/herself or not. The authentication information 17 includes fingerprint data for performing fingerprint authentication, face data for performing face authentication, voice data for performing voice authentication, a keyword, or a PIN (personal identification number) code.

The control portion 13 is connected to the network portion 11 and to the storage portion 12, and controls the operation of the entire monitoring device 10. The control portion 13 is an arithmetic processing circuit such as a microcomputer provided with a CPU (central processing unit), a ROM (read-only memory), a RAM (random access memory), and the like. The ROM stores a control program for controlling the operation of the monitoring device 10. The CPU in the control portion 13 reads the control program stored in the ROM and maps it on the RAM so as to function as a first position tracking portion 21, a second position tracking portion 22, an abnormality detecting portion 23, a mode switching portion 24, a measuring portion 25, and an authentication portion 26.

The first position tracking portion 21, based on wireless communication between the subject terminal 30 and the APs 70₁ to 70ₙ, tracks the position of the subject terminal 30. That is, the APs 70₁ to 70ₙ transmit the terminal ID of the subject terminal 30 with which wireless communication has been established to the monitoring device 10. The first position tracking portion 21 refers to the point position information 14, and thereby grasps the installation positions of the APs 70₁ to 70ₙ which have established wireless communication with the subject terminal 30 as the position of the subject terminal 30.

The second position tracking portion 22 tracks the position of the subject terminal 30 based on terminal position information received from the subject terminal 30.

Based on the position of the subject terminal 30 which is tracked by the first position tracking portion 21 and the activity range which is registered in the activity range information 15, the abnormality detecting portion 23 detects an abnormality when the subject terminal 30 is judged to be outside the activity range.

When the abnormality detecting portion 23 detects an abnormality, the mode switching portion 24 transmits to the subject terminal 30 and the watcher terminal 50 an abnormality monitoring notification indicating a switch to an abnormality monitoring mode.

When the abnormality detecting portion 23 detects an abnormality, the measuring portion 25, based on the position of the subject terminal 30 which is tracked by the second position tracking portion 22, measures the moving distance (distance traveled, linear distance) of the subject terminal 30 and the lapse of time after detection of the abnormality.

The authentication portion 26 checks a termination input received from the subject terminal 30 against the authentication information 17 and judges whether the termination input on the subject terminal 30 has been performed by the subject or not.

The subject terminal 30 is a mobile terminal with a position detection function such as a mobile phone, a smartphone, a tablet terminal, or a PDA (personal digital assistant). The subject terminal 30 is carried around by a watched subject. The subject terminal 30, as shown in FIG. 4, includes an image-taking portion 31 such as a camera, an operating portion 32 such as a touch panel which functions as display and input portions, an audio input portion 33 such as a microphone, an audio output portion 34 such as a speaker, a GPS communication portion 35, a wireless communication portion 36, a network portion 37, and a control portion 38.

The GPS communication portion 35 has a function of periodically detecting the current position (the longitude and latitude) using radiowaves from a GPS satellite.

The wireless communication portion 36 has a function of performing wireless communication with the APs 70₁ to 70ₙ. The wireless communication portion 36 attempts to communicate with the APs 70₁ to 70ₙ periodically and transmits the terminal ID of the subject terminal 30 to the APs 70₁ to 70ₙ with which communication has been established.

The network portion 37 has a function of transmitting and receiving various types of data via the network 60 to and from the monitoring device 10.

The control portion 38 is connected to each of the image-taking portion 31, the operating portion 32, the audio input portion 33, the audio output portion 34, the GPS communication portion 35, the wireless communication portion 36, and the network portion 37 and controls the operation of the entire subject terminal 30. The control portion 38 is an arithmetic processing circuit such as a microcomputer provided with a CPU (central processing unit), a ROM (read-only memory), a RAM (random access memory), and the like. The ROM stores a control program for controlling the operation of the subject terminal 30. The CPU in the control portion 38 reads the control program stored in the ROM and maps it on the RAM so as to function as a position information transmitting portion 39 and a termination acceptance portion 40.

The watcher terminal 50 is a mobile terminal with a position detection function such as a mobile phone, a smartphone, a tablet terminal, or a PDA (personal digital assistant). The watcher terminal 50 is carried around by a watcher who watches the activity of a subject. The watcher terminal 50, as shown in FIG. 4, includes an operating portion 51 such as a touch panel which functions as display and input portions, a network portion 52, and a control portion 53.

The network portion 52 has a function of transmitting and receiving various types of data via the network 60 to and from the monitoring device 10.

The control portion 53 is connected to each of the operating portion 51 and the network portion 52 and controls the operation of the entire watcher terminal 50. The control portion 53 is an arithmetic processing circuit such as a microcomputer provided with a CPU (central processing unit), a ROM (read-only memory), a RAM (random access memory), and the like. The ROM stores a control program for controlling the operation of the watcher terminal 50. The CPU in the control portion 53 reads the control program stored in the ROM and maps it on the RAM so as to function as a tracking information output portion 54.

Next, with reference to FIG. 5, a description will be given of watching operation by the monitoring system of this embodiment, taking an example where watcher B who carries the watcher terminal 50 performs watching operation. In the activity range information 15, the watcher information 16, and the authentication information 17 stored in the storage portion 12 of the monitoring device 10, registered in the activity range information 15 is activity range X of subject A, registered in the watcher information 16 is the terminal ID of the watcher terminal 50 carried by watcher B which is associated with the terminal ID of the subject terminal 30 carried by subject A, and registered in the authentication information 17 is data for verifying subject A.

The control portion 13 of the monitoring device 10 functions as the first position tracking portion 21 and waits for the reception of the terminal ID from the APs 70₁ to 70ₙ (step S101).

The first position tracking portion 21 which is notified of the terminal ID in step S101 refers to the point position information 14, and thereby grasps the installation location of the APs 70₁ to 70ₙ as notified of by the terminal ID as the current position of the subject terminal 30 (step S102).

Next, the control portion 13 functions as the abnormality detecting portion 23 to judge whether the current position of the subject terminal 30 identified in step S102 is within activity range X of subject A or not (step S103). In the example shown in FIG. 2, the subject terminal 30 which has established wireless communication with the APs 70₁ to 70₄ is judged to be within activity range X, and the subject terminal 30 which has established wireless communication with the APs 70₄ to 70₁₀ is judged to be outside activity range X.

When the subject terminal 30 is within activity range X in step S103, the procedure returns to step S101.

When the subject terminal 30 is outside activity range X in step S103, the abnormality detecting portion 23 senses abnormality (step S104), and the control portion 13 functions as the mode switching portion 24, the second position tracking portion 22, and the measuring portion 25. The mode switching portion 24 transmits the abnormality monitoring notification indicating a switch to the abnormality monitoring mode to the subject terminal 30 and the watcher terminal 50 (step S105). The second position tracking portion 22 starts to track the position of the subject terminal 30 with the GPS, and the measuring portion 25 starts measurement (step S106).

The abnormality detecting portion 23 monitors a case where a given terminal ID is not received for a predetermined time (step S107). Also a case where a given terminal ID is not received for a predetermined time leads to step S104 and an abnormality is detected.

The control portion 38 of the subject terminal 30 which has received an abnormality monitoring notification performs a switch to the abnormality monitoring mode and indicates by display on the operating portion 32 or by audio output from the audio output portion 34 that a switch to the abnormality monitoring mode has taken place. In the abnormality monitoring mode, the control portion 38 functions as the position information transmitting portion 39 and the termination acceptance portion 40.

The position information transmitting portion 39 transmits the current position detected by the GPS communication portion 35 to the monitoring device 10. That is, in the abnormality detection mode, the position tracking method is switched from the one by wireless communication between the wireless communication portion 36 and the APs 70₁ to 70ₙ to the one by the GPS communication portion 35. With this, the number of the APs 70₁ to 70ₙ can itself be reduced and the subject terminal 30 can be tracked continuously even when it is outside activity range X.

When the measurement by the measuring portion 25 is started in step S106, the control portion 13 of the monitoring device 10 waits for the reception of the current position and the termination input from the subject terminal 30 (steps S108 and S109 respectively).

When the current position is received from the subject terminal 30 in step S108, the second position tracking portion 22 grasps the current position of the subject terminal 30 (step S110), as well as functions as the abnormality detecting portion 23 to judge whether the current position of the subject terminal 30 identified in step S110 is within activity range X of subject A or not (step S111).

When it is outside activity range X in step S111, the second position tracking portion 22 and the measuring portion 25 transmit the current position of the subject terminal 30 and the measurement result respectively to the watcher terminal 50 (step S112), and the procedure returns to step S108.

The control portion 53 of the watcher terminal 50 which has received the abnormality monitoring notification functions as the tracking information output portion 54. The tracking information output portion 54 switches the watcher terminal 50 to the abnormality monitoring mode and notifies by display on the operating portion 51 or by audio output from an unillustrated audio output portion that a switch to the abnormality monitoring mode has taken place. In the abnormality monitoring mode, the tracking information output portion 54 receives the current position of the subject terminal 30 identified by the second position tracking portion 22 and the measurement result from the measuring portion 25 from the monitoring device 10 and displays them on the operating portion 51. With this, the watcher terminal 50 can, in the abnormality monitoring mode, check the current position of the subject terminal 30 continually. With the measurement result from the measuring portion 25, the moving distance (distance traveled, linear distance) of the subject terminal 30 and the lapse of time after detection of the abnormality can be grasped, and thus the degree of urgency can be easily grasped.

When the subject terminal 30 is within activity range X in step S111, the mode switching portion 24 transmits the abnormality monitoring mode termination notification to the subject terminal 30 and the watcher terminal 50 (step S113), and the procedure returns to step S101.

Upon receiving the termination notification, the control portion 38 of the subject terminal 30 and the control portion 53 of the watcher terminal 50 terminate the abnormality monitoring mode and return to the normal mode.

The termination acceptance portion 40 of the subject terminal 30 accepts the termination input requesting for the termination of the abnormality monitoring mode from either one or more of the image-taking portion 31, the operating portion 32, and the audio input portion 33, and transmits the accepted termination input to the monitoring device 10. The termination input is data (such as face data, voice data, fingerprint data, a keyword, or a PIN code) which is checked against the authentication information 17 stored in the storage portion 12 of the monitoring device 10. The termination acceptance portion 40 accepts through the image-taking portion 31 face data or fingerprint data of the subject as the termination input, or accepts through the audio input portion 33 voice data of the subject as the termination input. Or, the termination acceptance portion 40 accepts through the operating portion 32 a keyword or a PIN code as the termination input.

Upon receiving the termination input from the subject terminal 30 in step S109, the control portion 13 functions as the authentication portion 26 and checks the termination input received from the subject terminal 30 against the authentication information 17 to judge whether authentication is successful, that is, whether the termination input on the subject terminal 30 has been performed by the subject or not (step S114).

When authentication is successful in step S114, the procedure proceeds to step S113, and the abnormality monitoring mode termination notification is transmitted to the subject terminal 30 and the watcher terminal 50. In this case, it is preferable to transmit to the watcher terminal 50 the termination input along with the termination notification. When the termination input is, for example, face data or voice data, outputting the termination input from the watcher terminal 50 allows the watcher to recognize that the abnormality monitoring mode has been terminated by the subject, and this reassures the watcher.

When authentication is unsuccessful in step S114, the control portion 13 transmits to the watcher terminal 50 the termination input along with an authentication error (step S115). Then the procedure returns to step S108 and the abnormality monitoring mode is continued. In this case, by outputting the termination input from the watcher terminal 50, the watcher can grasp what termination input caused the termination error and judge the degree of risk.

Even after the abnormality monitoring mode is terminated with the termination input, until the subject terminal 30 returns to within the activity range, the position tracking of the subject terminal 30 by the second position tracking portion 22 and measurement by the measuring portion 25 can be continued. In this case, when the moving distance (distance traveled, linear distance) after the subject terminal 30 has gone outside the activity range exceeds a predetermined threshold distance, or when the period of stay outside the activity range exceeds a predetermined threshold time, a switch to the abnormality monitoring mode can be made again and another safety check can be requested.

When the abnormality monitoring mode is not terminated with the termination input, the frequency of notification to the subject terminal 30 and the watcher terminal 50 or the method of notification can be changed (so that notification is more frequent or louder).

As explained above, this embodiment deals with a monitoring system in which the subject terminal 30, the monitoring device 10, and the watcher terminal 50 are connected via a network. The subject terminal 30 is carried by the subject. The monitoring device 10 monitors the position of the subject terminal 30. The watcher terminal 50 is carried by the watcher who watches the subject. The monitoring device 10 includes the abnormality detecting portion 23, the mode switching portion 24, and the second position tracking portion 22. The abnormality detecting portion 23 senses an abnormality when the position of the subject terminal 30 goes outside a set activity range. When the abnormality detecting portion 23 senses an abnormality, the mode switching portion 24 transmits the abnormality monitoring notification indicating a switch to the abnormality monitoring mode to the subject terminal 30 and the watcher terminal 50. Upon receiving from the subject terminal 30 the termination input requesting for the termination of the abnormality monitoring mode, the mode switching portion 24 transmits the termination notification indicating the termination of the abnormality monitoring mode to the subject terminal 30 and the watcher terminal 50. The second position tracking portion 22 transmits the position of the subject terminal 30 to the watcher terminal 50 which is in the abnormality monitoring mode. The subject terminal 30 includes the termination acceptance portion 40. The termination acceptance portion 40, in the abnormality monitoring mode, accepts the termination input, and transmits the accepted termination input to the monitoring device 10. The watcher terminal 50 includes the tracking information output portion 54. The tracking information output portion 54, in the abnormality monitoring mode, outputs the position of the subject terminal 30 received from the monitoring device 10. With this configuration, the presence or absence of the termination input helps distinguish between an exceptional situation and a really abnormal situation, and thus the situation of the subject can be grasped during the abnormality notification.

In this embodiment, the monitoring device 10 includes the authentication portion 26 which verifies the termination input received from the subject terminal 30. When the authentication portion 26 verifies the termination input, the mode switching portion 24 transmits the termination notification to the subject terminal 30 and the watcher terminal 50. With this configuration, whether the termination input has been performed by the subject or not can be judged.

Furthermore, in this embodiment, the mode switching portion 24 transmits the termination input from the subject terminal 30 along with the termination notification to the watcher terminal 50. With this configuration, the situation of the subject can be grasped based on the termination input.

Furthermore, in this embodiment, the termination acceptance portion 40 accepts through the image-taking portion 31 face data as the termination input. With this configuration, the situation of the subject can be grasped based on face data.

Furthermore, in this embodiment, the audio input portion 33 accepts voice data as the termination input. With this configuration, the situation of the subject can be grasped based on voice data.

It is clear that the embodiment described above is in no way meant to limit the present disclosure, which thus allows for many modifications and variations within the spirit of the present disclosure. The numbers, positions, shapes, and other features of the components described above are not limited to those in the above embodiment. Instead, any suitable numbers, positions, shapes, and features can be adopted in carrying out the present disclosure. In the accompanying drawings, the same elements are assigned the same reference signs.

What is claimed is:

1. A monitoring system in which a subject terminal carried by a subject, a monitoring device for monitoring the position of the subject terminal, and a watcher terminal carried by a watcher who watches the subject are connected via a network,
wherein
the monitoring device includes
an abnormality detecting portion which senses an abnormality when the position of the subject terminal goes outside a set activity range,
a mode switching portion which, when the abnormality detecting portion senses an abnormality, transmits an abnormality monitoring notification indicating a switch to an abnormality monitoring mode to the subject terminal and the watcher terminal and which, upon receiving from the subject terminal a termination input requesting for the termination of the abnormality monitoring mode, transmits a termination notification indicating termination of the abnormality monitoring mode to the subject terminal and the watcher terminal, and
a position tracking portion which transmits the position of the subject terminal to the watcher terminal in the abnormality monitoring mode,
the subject terminal includes a termination acceptance portion which, in the abnormality monitoring mode, accepts the termination input and transmits the accepted termination input to the monitoring device, and
the watcher terminal includes a tracking information output portion which, in the abnormality monitoring mode, outputs the position of the subject terminal received from the monitoring device.

2. The monitoring system according to claim 1,
wherein
the monitoring device includes an authentication portion which verifies the termination input received from the subject terminal, and
the mode switching portion, when the authentication portion verifies the termination input, transmits the termination notification to the subject terminal and the watcher terminal.

3. The monitoring system according to claim 1,
wherein
the mode switching portion transmits the termination input from the subject terminal along with the termination notification to the watcher terminal.

4. The monitoring system according to claim 3,
wherein
the termination acceptance portion accepts via an image-taking portion face data as the termination input.

5. The monitoring system according to claim 3,
wherein
the termination acceptance portion accepts via an audio input portion voice data as the termination input.
